(19) United States
(12) Patent Application Publication
(10) Pub. No.: US 2006/0023228 A1
(43) Pub. Date: Feb. 2, 2006

(54) Custom fit facial, nasal, and nostril masks

(76) Inventor: Zheng Jason Geng, Rockville, MD (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/150,860

(22) Filed: Jun. 10, 2005

Related U.S. Application Data
(60) Provisional application No. 60/578,924, filed on Jun. 10, 2004.

(51) Int. Cl. G01B 11/24

(52) U.S. Cl. 356/601

(57) ABSTRACT

In one of many possible embodiments, the present system and method provides a process for fabricating a facial mask to custom fit a patient's face for a comfortable fit for facilitating various medical procedures including the steps of generating a 3D data set to define a portion of a patient's face to be fitted with a custom mask, fabricating a patient's mask utilizing a patient's 3D facial data set, and fitting a patient with a custom fit facial mask for facilitating a desired medical procedure.

### RELATED APPLICATIONS

The present application claims priority under 35 U.S.C. § 119(e) from the following previously-filed Provisional Patent Applications, U.S. Application No. 60/578,924, filed Jun. 10, 2004 by Geng, entitled “Custom Fit Facial/Nasal/Nostril Masks” which is incorporated herein by reference in its entirety.

### BACKGROUND

Obstructive Sleep Apnea (OSA) is a life threatening and life altering condition that occurs when a person repeatedly stops breathing during sleep because his or her airway collapses and prevents air from getting into the lungs. Statistics reveals that 18 million people in USA suffer from OSA, which is as common as diabetes and asthma. Currently Continuous Positive Airway Pressure (CPAP) is the most accepted and effective treatment for OSA. CPAP provides airflow to the patient via a nasal mask. The airflow holds, or “splints,” the airway open so air flows freely to the lungs of the patients. The CPAP treatment, however, requires a patient to wear a tightly fit nasal mask during the entire time they are sleeping. The patient-specific fit and comfort of the nasal mask is obviously very crucial to the success of CPAP treatment.

As mentioned earlier, OSA occurs when a person repeatedly stops breathing during sleep because his or her airway collapses and prevents air from getting into the lungs. The patients sleep is repeatedly disrupted by apneas, depriving these OSA sufferers from the deepest, most restful stages of sleep. This lack of sleep for the patient, in turn, affects daytime alertness and the patient's ability to function well throughout the day. The low oxygen levels associated with OSA, and the effort required to breathe during the night, put a strain on the patient's cardiovascular system as well. Ultimately, OSA takes its toll on the patient's quality of life.

The cycle of OSA starts with the patients snoring. The patient's airway then collapses or closes off. The patient tries to breathe but is unable to get air into his/her lungs through the collapsed airway and an apnea or a cessation of breathing occurs. The patient's brain realizes that it is not getting enough oxygen and fresh air and it wakes the patient from a deep level, to a lighter level, of sleep. The airway opens and normal breathing occurs. The patient, thus being able to breathe better, falls back into a deeper sleep, begins snoring again and the cycle repeats itself.

OSA can also cause blood pressure and heart problems for the patient. As mentioned earlier, OSA causes a patient's upper airway to collapse during sleep. The patient's brain realizes that it is not getting enough oxygen and wakes the patient from a deep level, to a lighter level, of sleep. Each time this happens, the patient's body produces chemicals or hormones that increase the heart rate and blood pressure. When the OSA suffering patient relaxes and goes back to a deep level of sleep, the heart rate drops back down to resting levels. This can happen hundreds of times while the patient is asleep. Each time the heart rate increases and decreases, blood pressure is affected. The elevation in blood pressure can last a few minutes or, as the severity of apnea increases, it can last all night. Nighttime fluctuations in blood pressure make it harder to control and maintain a healthy blood pressure. Over time, the repetitive increases in nighttime blood pressure lead to increased daytime blood pressure.

With proper OSA treatment, the patient's blood pressure does not experience the ups and downs at night caused by repeated apneas. The blood pressure is then easier to maintain and control during the day. Currently Continuous Positive Airway Pressure (CPAP) is the most accepted and effective treatment for OSA. CPAP provides airflow to the patient via a nasal mask. The airflow holds, or “splints,” the airway open so air flows freely to the lungs. With CPAP therapy, breathing for the patient becomes regular and snoring stops, oxygen level in the blood becomes normal, restful sleep is restored, quality of life is improved, and risk for high blood pressure, heart disease, heart attack, stroke, and vehicular or even work-related accidents is reduced.

The CPAP (Continuous Positive Airway Pressure) treatment method requires that a patient place a fitted mask to the facial, nasal, or nostril area of his or her face during the entire period of sleep. The fitting and comfort of a mask are extremely important to the success of the CPAP treatment. Nasal mask manufacturers usually offer a dozen of sizes and shapes of the same mask model. The selection of a mask that fits each individual patient is a practical problem since poorly-fitted masks can result in patient discomfort, fluid or air leaks, facial marks, conjunctivitis, and awakenings caused by mask discomfort or leaks. Poorly fitted masks also induce high treatment costs and may delay treatments for these often life threatening diseases.

Currently, there is no accurate mask selection tool to help practitioners in selecting a mask that correctly fits a patient. As stated earlier, poorly fitted masks result in the patient's discomfort, fluid or air leaks, facial marks, conjunctivitis, and awakenings caused by mask discomfort or leaks. Poorly fitted masks also induce high treatment costs and may delay treatments for these often life threatening diseases. To insure the fitting of a mask, a patient often needs to try multiple masks with different sizes and shapes to find one that fits well. Each mask can cost around $150 a piece. Furthermore, each of the opened packages of masks cannot be re-used for any other patient, therefore incurring a significant high cost in treatment procedures.

Beyond the OSA treatment, there are arrays of similar treatment procedures that require patient-specifically-fitted masks. Some examples include respiratory disorders (Bronchiectasis, Chronic Bronchitis, Chronic Obstructive Pulmonary Disease, Emphysema, Respiratory Syncytial Virus (RSV), etc), Cardiac (Cheyne-Stokes Breathing), neuromuscular (Amyotrophic Lateral Sclerosis (ALS), Muscular Dystrophy, Post Polio Syndrome, etc), and Asthma, Allergy or Sinusitis. Over the years, this has become a billion dollar market. A low cost and high performance mask selection tool would be very useful for improving the treatment outcomes, reducing the costs, simplifying the selection and shortening the time required for fitting a patient.

### SUMMARY

In one of many possible embodiments, the present system and method provides a process for fabricating a facial mask to custom fit a patient's face for a comfortable fit for facilitating various medical procedures including the steps of generating a 3D data set to define a portion of a patient's face to be fitted with a custom mask, fabricating a patient's mask utilizing a patient's 3D facial data set, and fitting a patient with a custom fit facial mask for facilitating a desired medical procedure.

Another embodiment of the present system and method provides a custom fit facial mask generated for an individual patent to facilitate medical treatments comprising a body member dimentioned to fit comfortably below the patient's nose, at least one projection member extending upward from a body member for fitting into one of a patient's nostrils wherein a projection member is structured to fit into a patients nostrils, a pipe like member connected to at least one end of a body member for conducting a gas like treatment medicine to a patient through a body member and a projection member.

Another embodiment of the present system and method provides a process for facilitating a customer selection of a custom fit facial mask comprising the steps of generating for a customer a 3D data set defining a portion of a customer's face to be fitted with a custom fit facial mask, permitting a customer to select a desired mask material, and utilizing a customer's 3D data set to modify an existing mask frame to select a proper fitting mask incorporating the selected material.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the system and method.

FIG. 1A is simplified block diagram illustrating the typical cycle of Obstructive Sleep Apnea (OSA) in a patient.

FIG. 1B is an anatomical diagram of the airflow of a patient who is experiencing normal breathing.

FIG. 1C is an anatomical diagram of the airflow of a patient suffering from Obstructive Sleep Apnea (OSA).

FIG. 2A is an anatomical diagram of the airflow produced by a Continuous Positive Airway Pressure (CPAP) apparatus.

FIG. 2B is a photograph depicting the Continuous Positive Airway Pressure (CPAP) apparatus being used for the treatment of Obstructive Sleep Apnea (OSA) in a patient.

FIG. 3 is a simplified block diagram of the 3D facial, nasal, or nostril mask fitting and/or selection system.

FIG. 4 is a simplified block diagram depicting various camera positions for obtaining 3D surface profiles.

FIG. 5 is a photograph and enlargement depicting the micro-features displayed under a high-resolution image.

FIG. 6 is a simple block diagram illustrating a 3D reconstruction algorithm.

FIG. 7 is a simple block diagram illustrating a reconstruction algorithm.

FIG. 8 is a simple block diagram illustrating the epipolar line for reducing the matching range of correspondence.

FIG. 9 is a graph depicting the Sum of Squared Difference (SSD) and the sum of Sum of Squared Difference (SSSD-in-inverse-distance) over a search zone defined by the epipolar constraints.

FIG. 10 is a simple block diagram depicting the software architecture.

FIG. 11A-11B are photographs illustrating the 3D profile in the mask contact region on a patient.

FIG. 11C-11D are diagrams of possible fitted mask models according a first embodiment of the present invention.

FIG. 12 is a simple block diagram depicting a nasal mask according a second embodiment of the present invention.

Throughout the drawings, identical reference numbers designate similar, but not necessarily identical, elements.

### DETAILED DESCRIPTION

The present specification discloses a process for fabricating a facial mask to custom fit a patient's face. More specifically, the present specification discloses a process for fabricating a facial mask to custom fit a patient's face wherein a 3D data set is used to define a portion of the patient's face to be fitted with a custom mask.

In the following description, for purposes of explanation, numerous specific details are set forth in order to provide a thorough understanding of the present system and method for providing a process for fabricating a facial mask to custom fit a patient's face wherein a 3D data set is used to define a portion of the patient's face to be fitted with said custom mask. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

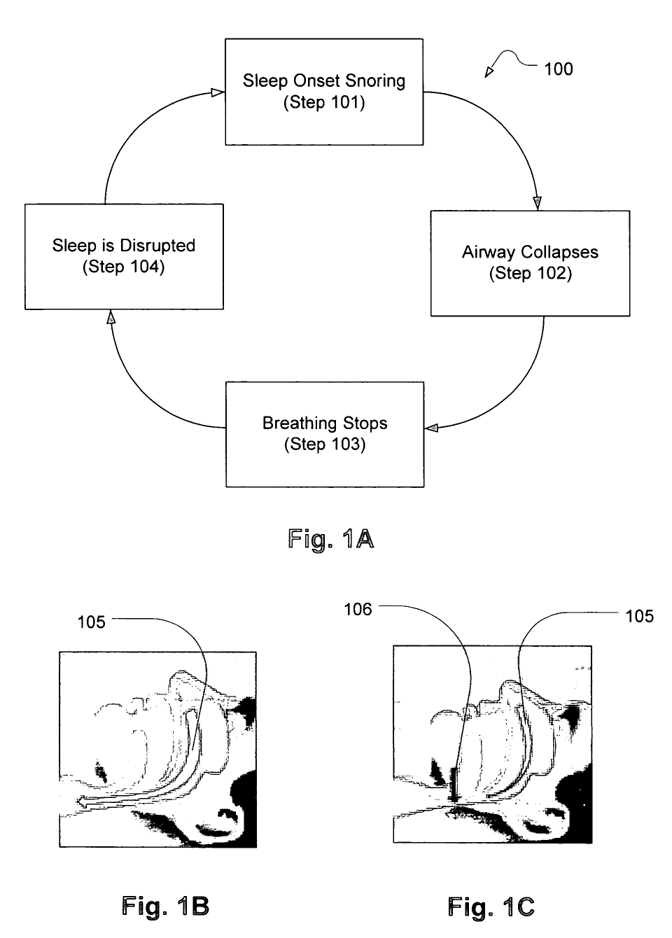

FIG. 1A depicts the cycle (100) of a typical patient suffering from Obstructive Sleep Apnea (OSA). The cycle of OSA (100) starts with the patient snoring (101). The patient's airway then collapses or closes off (102). The patient tries to breathe but is unable to get air into his/her lungs through the collapsed airway and an apnea or a cessation of breathing (103) occurs. The patient's brain realizes that it is not getting enough oxygen and fresh air and it wakes the patient from a deep level, to a lighter level, of sleep thus disrupting the patients sleep (104). The airway opens and normal breathing occurs. The patient, thus being able to breath better, falls back into a deeper sleep, begins snoring (101) again and the cycle (100) repeats itself.

FIG. 1B depicts anatomically the normal airflow (105) of a patient not suffering from Obstructive Sleep Apnea (OSA). This patient has an unblocked air passage and can freely breathe.

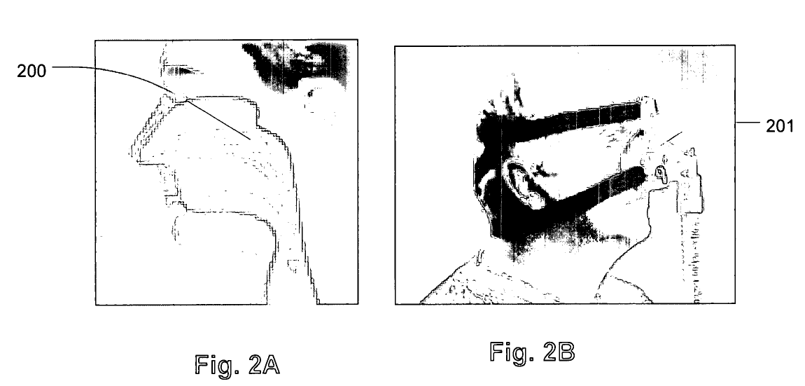

FIG. 2B depicts anatomically a patient's airway collapsing or closing off (106). The normal airflow (105) has been blocked by the collapsed airway (106).

FIG. 2A depicts anatomically the effects of the patient's use of a Continuous Positive Airway Pressure (CPAP). Continuous Positive Airway Pressure (CPAP) provides airflow (200) to the patient via a nasal mask. The airflow (200) holds, or “splints,” the airway open so air flows freely to the lungs. With Continuous Positive Airway Pressure (CPAP) therapy, breathing for the patient becomes regular and snoring stops, oxygen level in the blood becomes normal, restful sleep is restored, quality of life is improved, and risk for high blood pressure, heart disease, heart attack, stroke, and vehicular or even work-related accidents is reduced.

FIG. 2B depicts a patient wearing a typical version of a Continuous Positive Airway Pressure (CPAP) nasal mask (201).

The primary invention is a process of producing custom fit facial/nasal/nostril masks based on quantitative 3D measurements of individual patient's facial/nasal/nostril shapes.

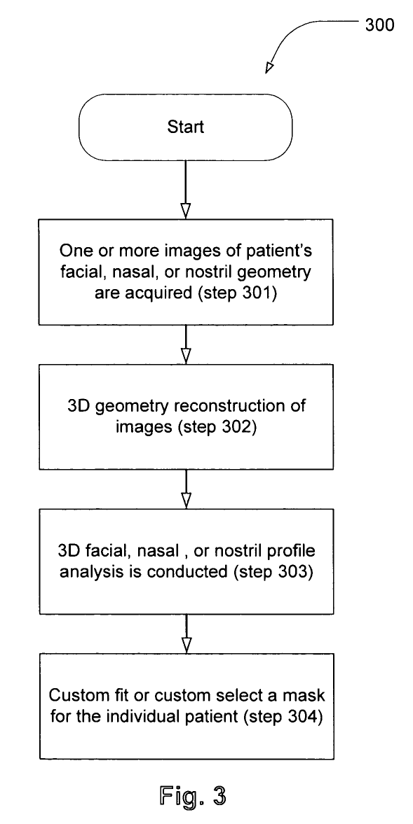

FIG. 3 illustrates the custom-fit and/or custom selection process (300) for a patient suffering from Obstructive Sleep Apnea (OSA). One or more images of patient's facial, nasal, or nostril geometry are acquired via 3D imaging or similar means (step 301). The 3D images accurately describe the 3D geometric profile of the contacting area between facial, nasal, or nostril tissue and the mask. The patient-specific facial profile will be analyzed by shape fitting software (step 302), which will perform computer-aided design (CAD) and derive quantitative “fitting index” (step 303). A facial, nasal, or nostril mask can then be custom fit or custom selected for a specific patient (step 304). In the case of custom-selected masks, the computer-aided design (CAD) software will recommend a list of specific manufacturers and mask models that best fit the patient, according to certain criteria. In the case of custom-made masks, the computer-aided design (CAD) data will be used to drive the computer-aided manufacturing system to produce a mask with a shape that will fit well to the individual patient. Note that even without the help of a 3D computer-aided design (CAD) or computer-aided manufacturing (CAM) system, the 3D measurement data can still help manual fabrication or selection of masks for the best possible fit.

There are abundant 3D imaging technologies that can provide accurate 3D measurement data of facial, nasal, or nostril areas for an individual patient. In the following discussions, a brief survey of existing 3D imaging techniques for general applications will now be presented.

Scanning Laser 3D Measurement Systems

One representative scanning laser 3D measurement product is Cyberware's 3D scanner. It projects a sheet of laser light onto objects sitting on a rotary table, and uses an image sensor to measure the location of the illuminated line on a 2D image. The best performance this type of 3D system can achieve is full surface scanning within several seconds. Furthermore, the laser scanner is expensive.

Laser Interferometer

A high accuracy method of measuring distance is based on the laser interferometer principle. A coherent laser beam impinges on a surface point of an object, and a receiving device collects the reflected beam. Any change in the phase of the received laser beam reflects the change in the distance of the object. The measurement accuracy of a laser interferometer is at the level of nanometers. However, this method is suited for point distance measurement, not a full-frame 3D imaging. Furthermore, any interruption of the laser beam during the measurement will cause the system to lose its reference signal, and therefore ruining the resulting measurements.

Stereo Vision

A conventional method of measuring a three dimensional (3D) surface profile of objects is the stereo vision. A stereo vision system uses two cameras to observe a scene just as our human's vision does. By processing two images the 3D surface profile of objects in the scene can be computed. The stereo method works by finding common features that are visible in both images. The three dimensional surface profile information can not be obtained from a single pixel; instead, a group of pixels are often selected in the areas of edges and corners. Stereo vision is often computationally intensive, and with today's state of the art computers, cannot be computed at frame rates.

Structured Illumination

In both the light stripe and the single dot approach, the projected feature must be scanned over the scene for an overall measurement to be made. The need for scanning may be removed and the efficiency of use of a 2D Charge Coupled Device (CCD) camera may be increased significantly by the projection of a pattern of light such as an array of dots, stripes, or a grid simultaneously onto the scene. However, the problem of ambiguity is aroused as to matching each of the stripes in the image with each of the projected strips. Furthermore, such a method can not achieve single pixel resolution of a range image because processing information from a group of pixels is required to determine the location of a structured light element (a dot or a stripe) in the image.

Range From Focus

It is possible to generate range data from focus information. Using a high-speed image processing computer the sharpness of an image can be measured in real time, at any point in the image where there is a distinguishable feature. There is a direct relationship between focus and range, so that if focus can be determined in real-time, range can likewise be determined in real-time. In order to determine the range to a multiplicity of points the sharpness of focus must be determined for each of those points. In order to obtain this information, many images must be captured with different focal distances. If a part of the image is determined to be in focus, then the range to that part of the image can be easily calculated. The focal length must, in effect, be swept from too close to just right to too far. Range from focus method, however, requires expensive hardware. It is also slow because many different focus settings must be used and, at each focus setting, a new image must be captured and analyzed. Furthermore, only the range to features can be computed.

Time-Of-Flight

3D ranging methods based on concept of time of flight measure directly the range to a point on an object by measuring the time required for a light pulse to travel from a transmitter to the surface and back to a receiver or by the measurement of the relative phase of modulated received and transmitted signals. The “laser radar” approaches actually scan with a single spot, and effectively measure the range to each point in the image one point at a time. Scanning of the light beam is required in order to obtain a full frame of range image, and hence is limited in speed.

Moiré Contouring

Moiré techniques use some form of structured light, typically a series of straight lines in a grating pattern, which is projected onto an object in the scene. This pattern on the object is then viewed from some other angle through a secondary grating, presenting a view of the first grating line which has been distorted by the contour of the part. The viewed image contains the moire beat pattern. To determine the 3D contour of the object, the moire techniques based on the phase shifting, fringe center mapping, and frequency shifting rely heavily on both extensive software analysis and rigorous hardware manipulation to produce different moire patterns of the same object.

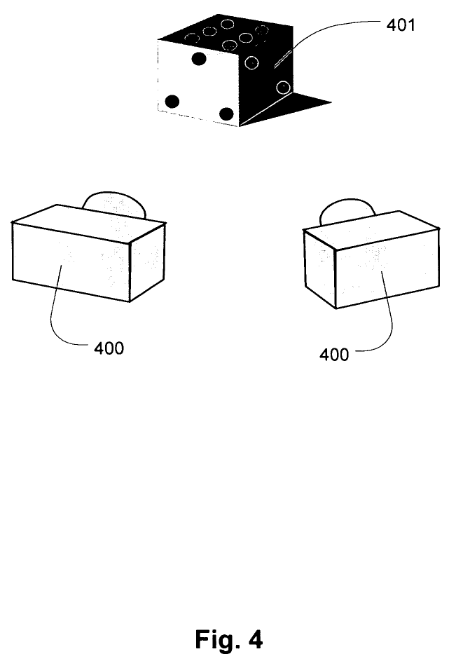

As seen in FIG. 4, in order to reduce the overall cost of a 3D imaging system, it is proposed that a single off-the-shelf digital camera (400) as the primary sensor be used. To obtain the 3D profile, multiple images must be taken by the camera from different viewing angles of an object (401). The technical challenge is to register the spatial geometric relationship among these free-form images and derive 3D surface profile from these 2D images.

A novel image registration method that is able to automatically calibrate the position and orientation of camera (400) positions thus providing the necessary constraints to perform stereo match is proposed. One of the major challenges for the registration of facial images is the human skin often does not provide enough salient features for matching in low resolution images. To solve this problem, most existing systems create features by projecting structured light onto a person's face so that the correspondence can be easily found. This does, however, incur a high cost.

Recently commercial off-the-shelf digital cameras have reached to unprecedented resolutions. A 6-megapixel digital camera costs only several hundred dollars, which may increase the resolution 5-6 times higher in both dimensions than the low-resolution video cameras used before such as NTSC image with have about 300k pixels and which is used in most existing video cameras. A high-resolution image reveals much higher detailed level of “micro-features” of a patient's facial skin. These facial micro-features could make the stereo matching more robust to achieve enough resolutions.

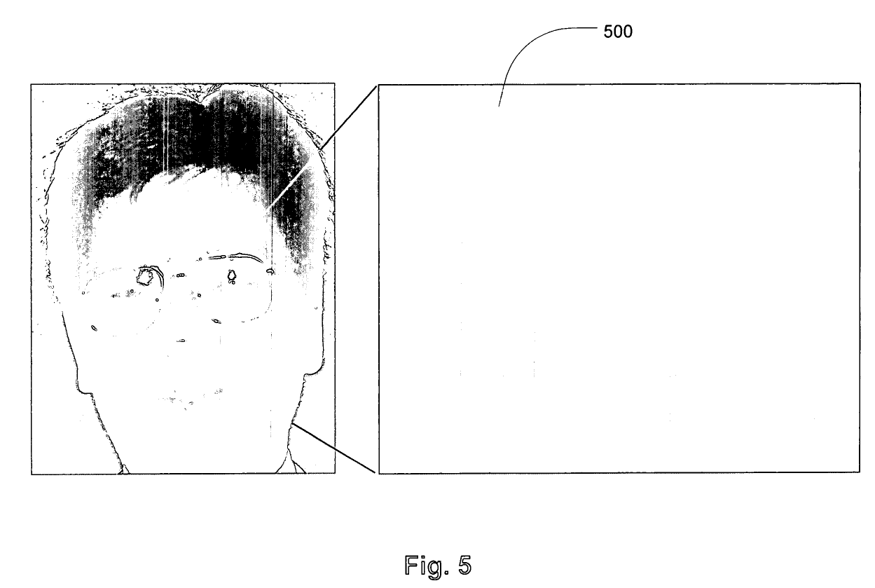

FIG. 5 shows a partial facial skin area (500) taken by a high resolution camera. We can see clearly that salient feature points can be found on the patient's skin.

The present algorithm is based on a single sensor multi-frame dynamic stereo methodology. Image sequences are acquired as the camera moves. Image pairs from two different camera locations are used to construct a 3D geometry of the tracked image and feature points. In addition, multiple image pairs are also used to increase the accuracy of the reconstructed 3D model of the patient's facial image.

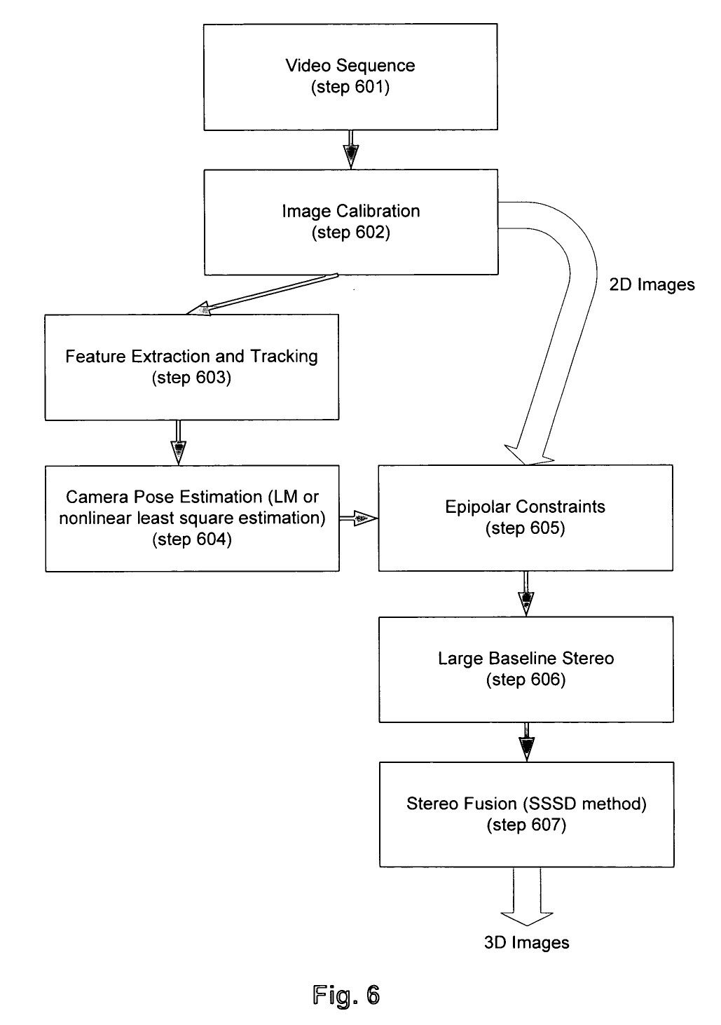

The 3D reconstruction method extends the traditional stereo concept to a framework called multi-frame dynamic stereo where a single moving camera is deployed. As shown in FIG. 6, after the video sequence (step 601), image calibration (step 602), and successful feature extraction and tracking (step 603), we use a nonlinear least square or Levenberg-Marquardt (LM) estimation method (step 604) to continuously estimate camera poses and 3D locations of the tracked features. The obtained camera pose information enables the localization of epipolar constraints (step 605) which is useful for dense map 3D reconstruction from an image pairs. Instead of using any image pairs of any baseline distances to construct 3D information of a scene, we only select pairs of large baseline distances (step 606), thus this greatly increases the accuracy and robustness of the reconstructed results. Reconstructed 3D information from multiple image pairs is fused through the Sum of Squared Difference (SSD) method (step 607) described hereafter.

Advantages of this reconstruction algorithm include using only a single camera, thus reducing the cost of the system and making it more feasible to be widely used by practitioners, offering stereo setup with flexible baseline distance, and providing higher 3D resolution from multiple image pairs of large baseline distances.

In fact, there are many real issues to model the face for the multi-frame dynamic stereo method. These include image calibration, automatic and reliable feature extraction and tracking, automatic and reliable camera pose estimation, 3D reconstruction from an image pair of a large baseline distance, high accuracy of 3D information reconstruction from multiple image pairs of large baseline distances, and solving the scaling issue. In the following, these practical issues will be addresses.

Image Calibration

Proper image calibration is needed to recover the intrinsic parameters of the system. These include the image center, aspect ratio, and focal length among other parameters. Genex has designed and calibrated the Rainbow 3D camera product. This experience will be leveraged and applied to the digital camera applications.

Automatic and Reliable Feature Extraction and Tracking

The feature extraction and tracking scheme through video sequence is based on the improved KLT (Kanade Lucas Tomasi) tracker. The KLT tracker incorporates some methodologies of Lucas and Kanade, and Tomasi and Kanade, as described in Bruce D. Lucas and Takeo Kanade, “An Iterative Image Registration Technique with an Application to Stereo Vision”, International Joint Conference on Artificial Intelligence, pages 674-679, 1981 and Carlo Tomasi and Takeo Kanade, “Detection and Tracking of Point Features”, Carnegie Mellon University Technical Report CMU-CS-91-132, April 1991, which are incorporated herein by reference in their entireties. Briefly, good features are found by examining the minimum eigenvalue of each 2 by 2 gradient matrix, and features are tracked using a Newton-Raphson method of minimizing the difference between the two windows.

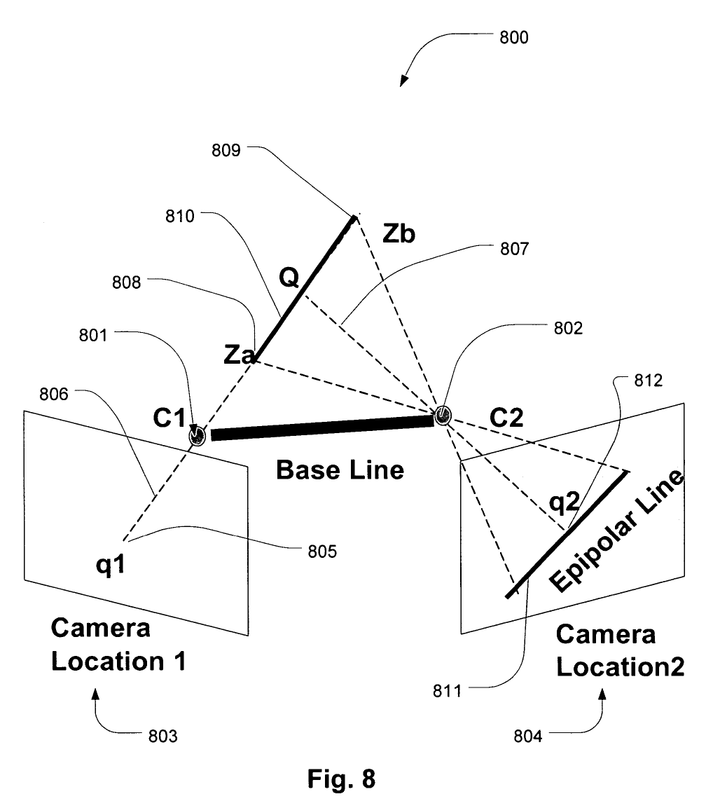

After having the corresponding feature points on multiple images, 3D scene structure or camera motion from those images can be recovered from the feature correspondence information. Jianbo Shi and Carlo Tomasi's “Good Features to Track”, IEEE Conference on Computer Vision and Pattern Recognition, pages 593-600, 1994, and Stan Birchfield's “Derivation of Kanade-Lucas-Tomasi Tracking Equation”, Unpublished, May 1996, which are incorporated herein by reference in their entireties, are good approaches to solve this problem. But the results are either unstable or need the estimation of ground truth. In FIG. 8, a unit vector of translation T can be obtained.

Automatic Camera Pose Estimation

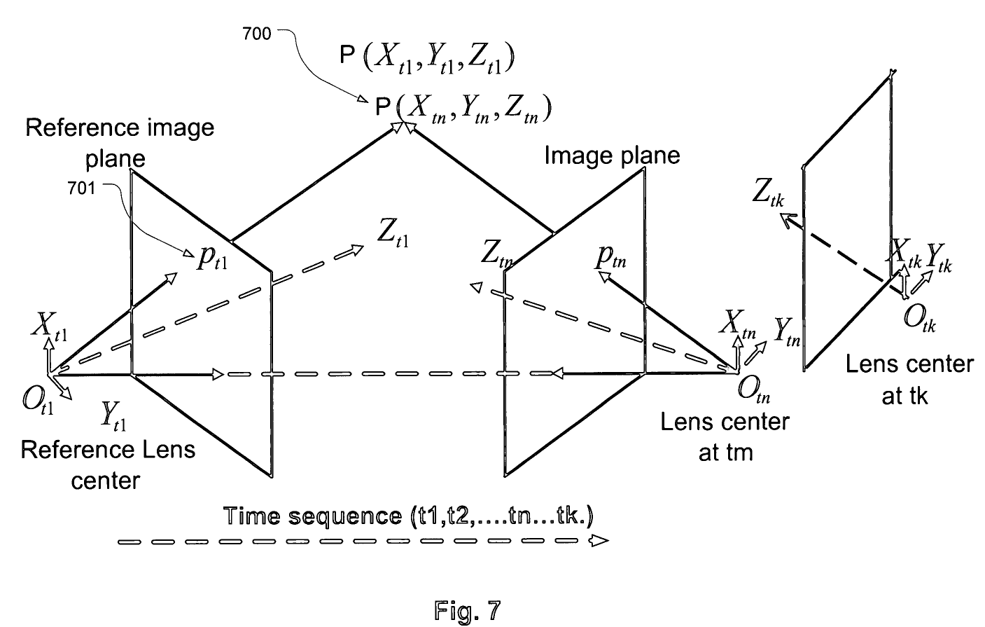

Camera pose estimation is another important step towards solving the 3D information of viewed scene. FIG. 7 shows a simple block diagram illustrating a reconstruction algorithm. A nonlinear least squares structure from motion method may be implemented as discussed in prior art to Szeliski.

Suppose m images have been acquired and there are n 3D points tracked. Let 3D point iε55 1, . . . , n} be represented by three-vector Pᵢ (Xᵢ, Yᵢ, Zᵢ) (700) giving its location in a world coordinate system, and its image represented by the two-vector pᵢⱼ(xᵢⱼ, yᵢⱼ) (701) (where jε{1, . . . , n}). We define a camera coordinate system for each image, and let camera position j be represented by the rotation Rⱼ(q₁ⱼ,q₂ⱼ,q₃ⱼ,q₄ⱼ) and translation Tⱼ=(tⱼₓ, t_{jy}, t_{jz}) of the world-to-camera coordinate system transformation for image j, where q₁ⱼ,q₂ⱼ,q₃ⱼ,q₄ⱼ are the quaternions of the camera rotation.

Let Π: R₃→R₂ be the projection which gives the 2D image location for a three dimensional point. Π depends on the camera intrinsic parameters (e.g. center of image), the omni-lens-to-camera transformation, and the Omni-lens structure, which are all assumed known through calibration. Since Π operates on 3D points specified in the camera coordinate system, the projection of a 3D point Pᵢ (700) specified in the world system is Π (RⱼPᵢ+Tⱼ).

To recover the camera motion and structure parameter, we use the Levenberg-Marquardt (LM) algorithm as mentioned in FIG. 6, which iteratively adjusts the unknown shape and motion parameters {pᵢⱼ} (701) and {Rⱼ, Tⱼ} to minimize the weighted square distance between the predicted and observed feature coordinates:
σ=Σ∥pᵢⱼ−Π(RⱼPᵢ+Tⱼ∥²
where the summation is over all i,j such that point i was observed in image j.

While it is possible that LM converges to a local minimum, a unique scene pattern to be printed on the interior balloon can be designed to avoid this situation. From extensive experience in applying the Levenberg-Marquadt technology for 3D face recognition one may leverage their experience on nonlinear parameter estimation for camera pose estimation.

Epipolar Constraint for Dense Map

To recover the dense 3D map of the viewed scene, one would need to locate the correspondences of the image points from the image stereo pairs. To reduce the searching area, with the help of the recovered camera pose information, Epipolar constraints can reduce the search dimension from 2D to 1D. Under a pinhole model of an imaging sensor (800), one can establish the geometric relationship in a stereo imaging system, as shown in FIG. 8, where C1 (801) and C2 (802) are the focal points of Camera location 1 (803) and Camera location 2 (804). Given any pixel q1 (805) in an image from Camera location 1 (803), a line of sight <q1, Q, infinite>(806) can be formed. In practical implementation, we assume possible Q (807) lies within a reasonable range between Za (808) and Zb (809). All possible image points of Q (807) along the line segment <Za,Zb>(810) project onto the image plane of Camera location 2 (804), forming an Epipolar line (811). Therefore, the search for a possible match of q1 (805) can be performed along a 1D line segment. Correspondence match between q1 (805) and q2 (812) provide sufficient information to perform triangulation that computes the (x,y,z) of any point Q (807) in 3D space.

3D Reconstruction from an Image Pair of a Large Baseline Distance

While 3D reconstruction of a viewed scene can be theoretically constructed from any image pairs, due to the errors from the camera pose estimation and feature tracking, image pairs of small baseline distances will be much more sensitive to noise, resulting in unreliable 3D reconstruction. In fact, given the same errors in camera pose estimation, the bigger the baseline distance is, the smaller error the reconstructed 3D information will be.

The present method and system's innovative concept of using only image pairs of large baseline distances takes full advantage of stereo formation, resulting in high resolution 3D information to satisfy the stringent spatial resolution requirement. In the meantime, since the present method and system's approach tracks features with video rate, our approach avoids feature miss tracking and reduces errors of camera pose estimation. In the present method and system, a large baseline distance is defined based on time sequence and feature disparity. If the time sequence gap and feature disparities of an image pair is greater than certain thresholds, this image pair will be perceived with a large baseline distance.

Reliable and High Resolution 3D Reconstruction from Multiple Image Pairs of Large Baseline Distances

Instead of using a single image pair for a 3D point reconstruction, the present system and method proposes an innovative solution using multiple image pairs of different baseline distances (all satisfying the “large baseline distance” requirement discussed earlier). This allows a reduction in the noise and further improve the accuracy of the 3D distance. The present system and method's multi-frame 3D reconstruction is based on a simple fact from the stereo equation:

$$\frac{Δ d}{B} = \frac{f}{Z} = f * \frac{1}{Z} = λ$$

This equation indicates that for a particular data point in the image, the disparity (Δd) divided by the baseline length (B) is constant since there is only one distance (Z) for that point (f is focal length). If any evidence or measure of matching for the same point is represented with respect to □, it should consistently show a good indication only at the single correct value of □ independent of B. Therefore, if one were to fuse or add such measures from the stereo of multiple baselines (or multi-frames) into a single measure, one may expect that it will indicate a unique match position.

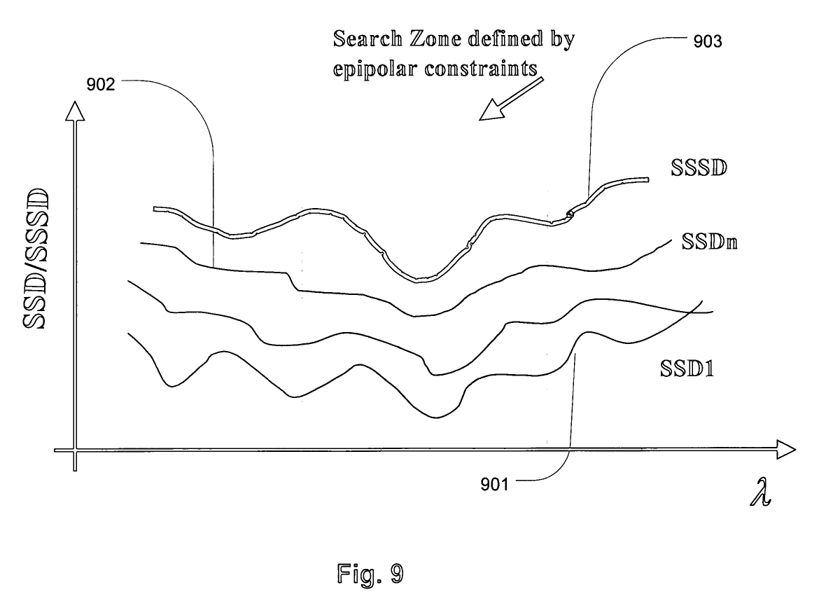

The SSD (Sum of Squared Difference) over a small window is one of the simplest and most effective measures of image matching. For a particular point in the base image, a small image window is cropped around it, and it is slid along the Epipolar line of other images. The SSD values are then computed for each disparity value. As shown in FIG. 9, the curves SSD1 (901) to SSDn (902) show typical curves of SSD values with respect to □ for individual stereo image pairs. Note that these SSD functions (901, 902) have the same minimum position that corresponds to the true depth. We add up the SSD functions (901, 902) from all stereo pairs to produce the sum of SSDs, which may be called SSSD-in-inverse-distance (903). The SSSD-in-inverse-distance (903) has a more clear and unambiguous minimum. Also, one should notice that the valley of the SSSD curve (903) is sharper, meaning that one may localize the minimum position more precisely, thereby producing greater precision in depth measurement. Obviously, this idea works for any combination of baselines. The computation is completely local, and does not involve any search, optimization, or smoothing. All the algorithm has to do is to compute the SSD functions (901, 902), scale and sum them to obtain the SSSD function (903), and locate the single minimum for each pixel, which is guaranteed to exist uniquely.

Solving the Scaling Issue

While the camera's intrinsic parameters can be obtained through calibration process, one cannot compute the true camera baseline distances, therefore one can only recover the viewed scene with a scale factor. This poses an important challenge for nose modeling where the exact size of the nose needs to be known. To solve this problem, the present system and method will design and place a calibration pattern with known dimension on the top and the bottom of the nose. Since the system method described above can recover the 3D information of any 3D feature up to a scale, this scale is easily obtained from the absolute distance of any two 3D feature points.

Summary of Proposed 3D Image Reconstruction Method

The present system and method proposes herein a novel approach to acquire high resolution 3D surface profile of facial and nasal areas using single off-the-shelf digital camera. A few digital images are first taken from lightly different viewing angles of the facial area. The system and method will then apply a reliable feature extraction algorithm (the KLT) to obtain consistent feature points from these digital images. The system and method will estimate the camera poses corresponding to each image using improved LM optimization technique. The system and method will use Epipolar line constraint to perform a correspondence search among image pairs. The system and method will use multi-baseline stereo techniques to reconstruct 3D surface image. The system and method will then use the VirtualFit software to perform surface profile analysis. The system and method will then compare the patient surface profile with that of various masks and extract the fitting index, based on a recommended list of mask models which are provided. The operator can use GUI to finally verify the fitting of the selected mask on the patient's face image.

There are several components in the 3D image processing algorithms: including facial micro-feature extraction; feature matching and tracking; 3D image generation with images from different viewing angles acquired by single high-resolution digital camera; the transformation of multiple 3D images acquired in different coordinate systems into a common coordinate system; and the merging of multiple registered 3D images into a seamless 3D model.

Micro-Feature Extraction

A good feature is a textured patch with high intensity variation in both x and y directions, such as a corner. Denote the intensity function by I(x, y) and consider the local intensity variation matrix as

$$Z = [ \begin{matrix}\frac{{\partial }^{2} I}{\partial {x}^{2}} & \frac{{\partial }^{2} I}{\partial x \partial y} \\ \frac{{\partial }^{2} I}{\partial x \partial y} & \frac{{\partial }^{2} I}{\partial {y}^{2}}\end{matrix} ]$$

A patch defined by a 25×25 window is acceptable as a candidate feature if both eigenvalues of Z, λ, and δ₁, exceed a predefined threshold λ: min (λ₁, λ₂)>λ in the center of the window.

Stereo Matching Algorithm

The essence of stereo matching is that given a point in one image, one can find its corresponding point in another image. The paired points on these two images are the projections of the same physical point in 3D space. This task requires a criterion to measure similarity between these two images.

The sum of squared difference (SSD) (901, 902 in FIG. 9) of color and/or intensity values over a window is the simplest, most widely used criterion to perform stereo matching. In its simple form, the sum of squared difference (SSD) (901, 902 in FIG. 9) between an image window in Image 1 and an image window of the same size in Image 2 is defined as:

$${C}_{12} ( {x}_{1} , ξ ) = {\sum }_{i ε W} \{ {( {r}_{1} ( {x}_{1} + i ) - {r}_{2} ( ξ + i ) ]}^{2} + {[ {g}_{1} ( {x}_{1} + i ) - {g}_{2} ( ξ + i ) ]}^{2} + {[ {b}_{1} ( {x}_{1} + i ) - {b}_{2} ( ξ + i ) ]}^{2} \}$$

where the sum means summation over a window. x₁ and ξ are the index of central pixel coordinates, and r, g, and b are the values of (r, g, b) representing the pixel color.

To reduce the searching area, Epipolar constraints can reduce the search dimension from 2D to 1D. To improve the quality of the match, we use a subpixel algorithm, and we also check the left-right consistency to remove false matches.

Generating 3D Image

By going through proper lens equations, coordinate transformations, and epipolar constrains, the following relationship presents itself:
(p′)^{T}F p=0

where F=(M′)⁻¹ E M⁻¹.

F is the famous essential matrix, E is the fundamental matrix where camera rotation and translation are embedded, M is camera intrinsic matrix, and p and p′ are image coordinates at two camera locations. In general, we will need 8 points to solve the camera's pose information.

3D Reconstruction with High-Resolution

For a reliable and high resolution 3D reconstruction, the present system and method will implement an innovative solution using multiple image pairs of different baseline distances instead of using a single image pair for a 3D point reconstruction. This allows the present system and method to reduce the noise and improve the accuracy of the 3D distance.

3D Custom-Fit Software Architecture

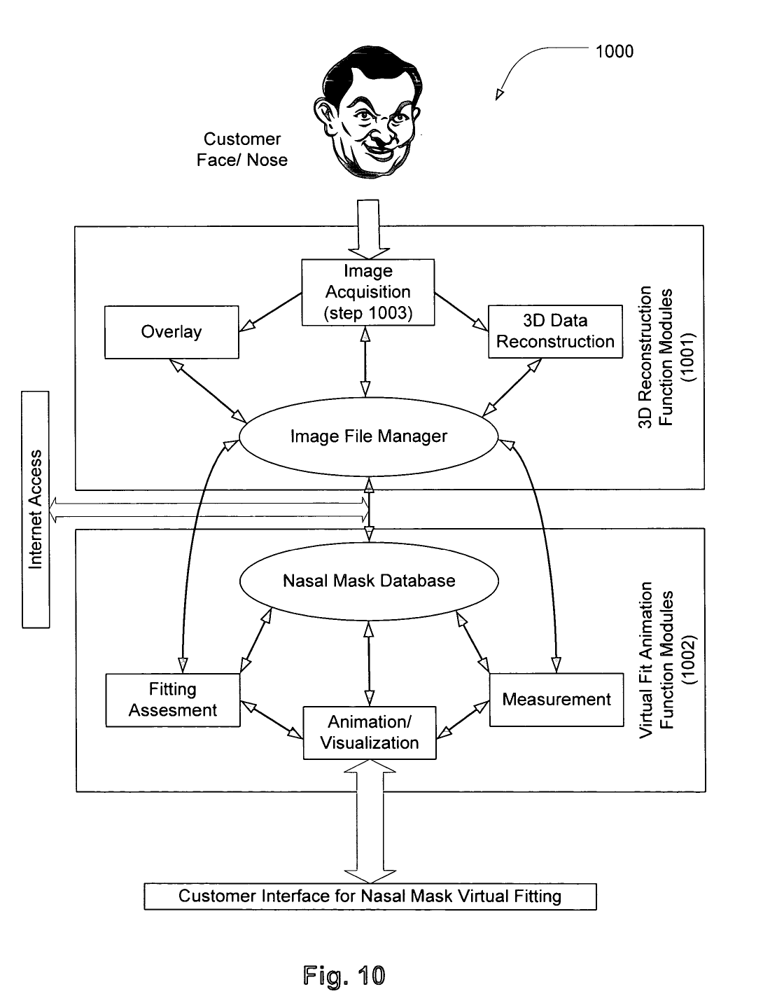

Referencing to FIG. 10, a full-scale software architecture (1000) is necessary to ensure the effectiveness of the custom-fit mask production and/or selection processes. The present system and method's software contains a comprehensive set of functions in image acquisition, editing, visualization, measurement, alignment and merge, surface model, texture overlay and database management. The present system and method's software architecture (1000) has two modules. A 3D data reconstruction module (1001) and a Virtual Fit Animation Module (1002).

Once an accurate 3D facial image is acquired (step 1003) by a 3D camera, the 3D geometric surface profile can be extracted within the regions that are within the vicinity of the contact line of a mask.

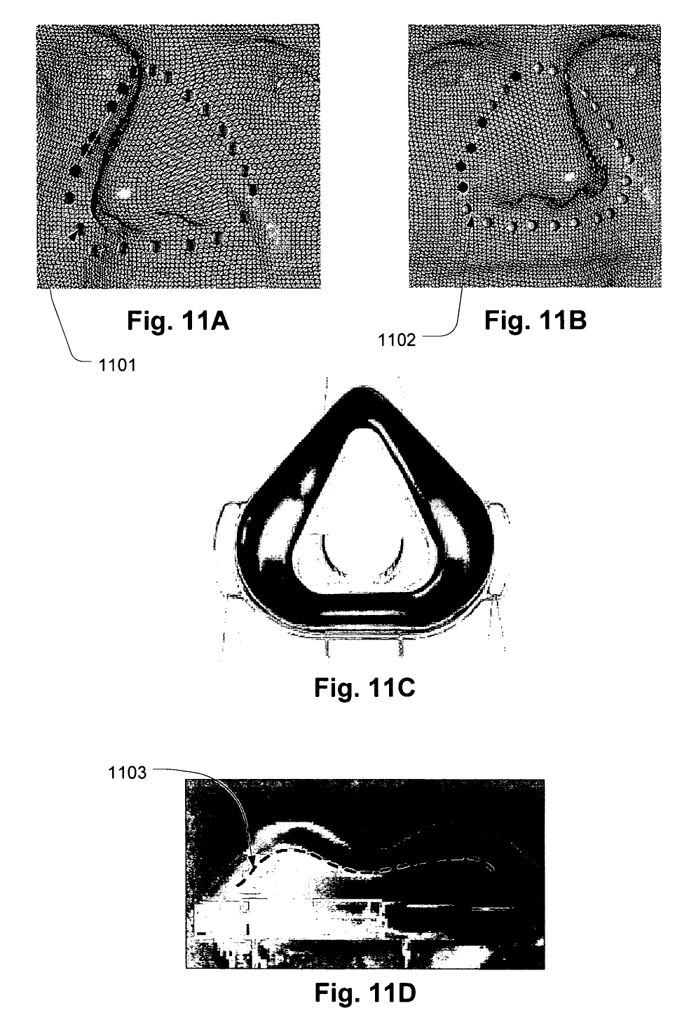

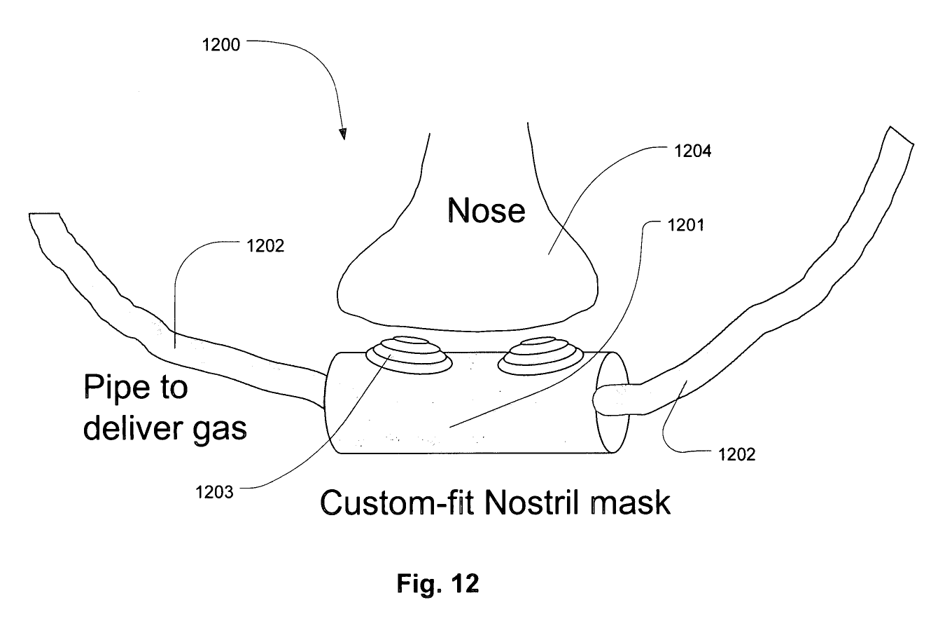

FIGS. 11A and 11B show an example of a 3D profile in the mask contact region (1101, 1102).

FIG. 11C and 11D show how one may analyze the possible fitting of a particular mask model. The user may first use the VirtualFit software to “register” the top point of the mask with the upper point on the nose directly on the 3D image. Using a facial symmetrical assumption, the present system and method can then use the 3D measurement software to virtually lay the mask on the nose to simulate the fitting in the virtual facial model. The 3D geometric difference (1103) within the contacting area between the mask shape and the facial profile can be quantified as the fitting error of this particular mask model.

This virtual fit can let patient try as many nasal mask models as possible, and identify the best fitted mask in terms of geometric shape and size without the physical touch with those masks, therefore, reducing the cost significantly. A user can also rank various mask models according to the fitting index to this particular patient. This fitting rank, together with other factors, such as cost, compatibility of particular air pressure device, will be used to select the best-fit mask for the patient.

Custom Fit Nostril Mask

There are many designs for facial and nasal masks. However, to reduce the size and weight, a new type of mask that is based on the fitting of the 3D shape of the patient's nostrils may be implemented. The 3D geometric shape of the patient's two nostrils is first acquired by a 3D imaging device. The shape of the patient's two nostril plugs (1203) are custom designed and made based on the acquired 3D measurement data. Through this, a custom-fit nostril mask (1200) may be designed and custom fit to each individual patient. This mask may have an elongated body member (1201) which would be fit comfortably under the patient's nose (1204). A pipe like member (1202) may be attached to the body member (1201) to facilitate the deliverance of a gas treatment to the patient.

Beyond the nasal mask fitting applications, the ultra-low-cost 3D camera can have significant impact on many other medical imaging applications, such as plastic and reconstructive surgery, cancer treatment, small animal imaging, custom-fit clothing, gaming, etc. The 3D image data collected may also be used for a custom-design mask to achieve a perfect fit. The success development of this critical technology will not only help solve the critical need of medical diagnosis and treatments of many diseases, but also result in significant sales of commercial products to many other markets due to the technology breakthrough in ultra-low cost of 3D imaging systems.

In conclusion, the present system and method provides a process for fabricating a facial mask to custom fit a patient's face wherein a 3D data set is used to define a portion of the patient's face to be fitted with a custom mask.

The preceding description has been presented only to illustrate and describe embodiments of the system and method. It is not intended to be exhaustive or to limit the system and method to any precise form disclosed. Many modifications and variations are possible in light of the above teaching.

What is claimed is:

1. A process for fabricating a facial mask to custom fit a portion of a patient's face for a comfortable fit for facilitating various medical procedures comprising the steps of:
generating a 3D data set to define said portion of said patient's face to be fitted with said custom mask, fabricating said patient mask utilizing said patient's 3D facial data set, and fitting said patient with said custom fit facial mask for facilitating said desired medical procedure.

2. The process of claim 1, wherein said facial mask is custom fit for one or more of said patient's nasal passages.

3. The process of claim 1, wherein said facial mask is custom fit for one or more of said patient's nostrils.

4. The process of claim 1, wherein said patient's mask is fabricated utilizing said patient's 3D data set to activate a Computer-Aided Design (CAD) process.

5. The process of claim 1, wherein said 3D facial data set is generated utilizing a 3D imaging technique.

6. The process of claim 5, wherein said 3D imaging technique utilizes a Kanade Lucas Tomasi extraction algorithm, to generate said 3D facial data set.

7. The process of claim 1, wherein said facial mask includes, but not limited to, a full facial mask, a nose mask, a nostril mask or a nasal mask.

8. The process of claim 1, wherein the step of fabricating said patient mask utilizing said patient's 3D facial data set may be used to modify an existing mask to ensure proper fit.

9. A process for fabricating a facial mask to custom fit a portion of a patient's face for a comfortable fit for facilitating various medical procedures comprising the steps of:
generating a 3D data set via a multi-frame dynamic stereo imaging technique to define said portion of said patient's face to be fitted with said custom mask,
fabricating said patient mask utilizing said patient's 3D facial data set, and
fitting said patient with said custom fit facial mask for facilitating said desired medical procedure.

10. The process of claim 9, wherein said facial mask is custom fit for one or more of said patient's nasal passages.

11. The process of claim 9, wherein said facial mask is custom fit for one or more of said patient's nostrils.

12. The process of claim 9, wherein said patient's mask is fabricated utilizing said patient's 3D data set to activate a Computer-Aided Design (CAD) process.

13. The process of claim 9, wherein said facial mask includes, but not limited to, a full facial mask, a nose mask, a nostril mask or a nasal mask.

14. The process of claim 9, wherein said multi-frame stereo imaging technique uses a feature extraction algorithm to obtain consistent feature points of said patient's face from digital images.

15. The process of claim 9, wherein said multi-frame stereo imaging technique uses an estimation method to continuously estimate camera poses and 3D locations of said tracked features of said patient's face.

16. The process of claim 9, wherein the step of fabricating said patient mask utilizing said patient's 3D facial data set may be used to modify an existing mask to ensure proper fit.

17. A custom fit facial mask generated for a patient to facilitate a medical treatment via said patient's nostrils comprising:
an elongated body member dimentioned to fit comfortably below said patient's nose,
at least one projection member extending upward from said body member for fitting into at least one of said patient's nostrils wherein said projection member is structured to fit firmly into said patients nostrils,
a pipe like member connected to at least one end of said body member wherein said projection member, elongated body member and said pipe like member are communicatively coupled so as produce an airway for conducting a gas like treatment to said patient's nostrils,
wherein said patient's nostril profile is based upon a 3D facial data set profile of said patient's nose.

18. The custom fit facial mask of claim 17, wherein said 3D facial data set is generated utilizing a 3D imaging technique.

19. The custom fit facial mask of claim 17, wherein said 3D imaging technique utilizes a Kanade Lucas Tomasi extraction algorithm, to generate said 3D facial data set profile.

20. The custom fit mask of claim 17, additionally including a support for attaching said body member to said patient's head.
